(19) United States
(12) Patent Application Publication
(10) Pub. No.: US 2019/0323538 A1
(43) Pub. Date: Oct. 24, 2019

(54) TORQUE LIMITING THREADED FASTENER AND METHOD OF USE

(71) Applicant: Coty D. Link, Coronado, CA (US)

(72) Inventor: Coty D. Link, Coronado, CA (US)

(21) Appl. No.: 16/382,691

(22) Filed: Apr. 12, 2019

Related U.S. Application Data
(60) Provisional application No. 62/661,808, filed on Apr. 24, 2018.

(51) Int. Cl. F16B 31/02; F16B 37/00

(52) U.S. Cl. CPC F16B 31/02; F16B 37/00

(57) ABSTRACT

A torque-limiting threaded fastener including a specially designed set of bolts and nuts outfitted with a unique anterior and interior configuration of retractable, gripping teeth components structured and arranged to provide an easy means of preventing stripped bolts while also improving torque load on the bolts.

### CROSS-REFERENCE TO RELATED APPLICATION

The present application claims priority to U.S. Provisional Patent Application No. 62/661,808, filed, Apr. 24, 2018 under 35 U.S.C. 119, and is incorporated by reference herein.

### BACKGROUND OF THE INVENTION

### Field of the Invention

The present invention relates generally to the field of threaded fasteners and more specifically relates to a specially designed set of bolts and nuts outfitted with a unique anterior and interior configuration of retractable, gripping teeth components structured and arranged to provide an easy means of preventing stripped bolts while also improving torque load on the bolts.

### Description of the Related Art

In today's civilization, there are tools designed for virtually any function or task which can be imagined. One of the more commonly used tools is the box wrench, a tool that has been used since nuts and bolts were first invented. A development which provided a big advantage over conventional wrenches, and most hand tools in general, was the introduction of the ratchet type wrench. Using a ratchet wrench, one can tighten or remove almost any nut or bolt, regardless of how stubborn or awkwardly located, with the proper accessory. A ratchet is a mechanical device that transmits intermittent rotary motion or permits a shaft to rotate in one direction but not in the opposite direction. This device is incorporated on socket wrench drive tools for tightening or loosening nuts and bolts where a complete revolution is impossible.

However, as multifaceted as common sockets can be, they are typically no match for bolts, nuts, and screws that have been stripped of their sharpened points that allow of easy gripping. Impossible to remove via screwdrivers or other types of wrenches, stripped nuts and bolts also cannot be tightly held, as needed, by the relatively smooth interior of sockets. As annoying as encountering stripped fasteners can be, not possessing a tool that can remove them can prove downright frustrating.

Various attempts have been made to solve problems found in threaded fasteners art. Among these are found in: U.S. Pat. No. 3,289,524 to Rubin Norman N; U.S. Pat. No. 4,687,392 to Robert E. Bidwell; and U.S. Pat. No. 3,709,087 to Stone W. This prior art is representative of torque limiting threaded fasteners.

Thus, a need exists for a torque-limiting threaded fastener, which includes a specially designed set of bolts and nuts outfitted with a unique anterior and interior configuration of retractable, gripping “teeth” components structured and arranged to provide an easy means of preventing stripped bolts while also improving torque load on the bolts and to avoid the above-mentioned problems.

### SUMMARY

In view of the foregoing disadvantages inherent in the known threaded fastener device art, the present invention provides a torque-limiting threaded fastener, which includes a specially designed set of bolts and nuts outfitted with a unique anterior and interior configuration of retractable, gripping teeth components structured and arranged to provide an easy means of preventing stripped bolts while also improving torque load on the bolts.

Another aspect of the invention involves a torque limiting threaded fastener comprising a bolt with external threads; an inside collar with internal threads that threadably receive the external threads of the bolt, the inside collar including a plurality of external protrusions; an outside collar that receives that inside collar, the outside collar including a plurality of internal protrusions, wherein when the bolt is rotated a predetermined torque amount, the plurality of external protrusions of the inside collar slip past the plurality of internal protrusions of outside collar, limiting torque and prevent stripping in the torque limiting threaded fastener.

One or more implementations of the aspect of the invention described immediately above includes one or more of the following: the outside collar includes elastic material that compresses when the bolt is rotated a predetermined torque amount so that that the plurality of external protrusions of the inside collar slip past the plurality of internal protrusions of outside collar; the elastic material of the outside collar is cylindrical and circumferentially surrounds the plurality of internal protrusions of the outside collar; the plurality of external protrusions of the inside collar are at least one of serrations and triangles; the plurality of external protrusions of the inside collar includes rows of external protrusions that extend a longitudinal length of an exterior of the inside collar; the rows of external protrusions extend an entire circumference of the exterior of the inside collar; the plurality of internal protrusions of the outside collar are at least one of serrations and triangles; the plurality of internal protrusions of the outside collar includes rows of internal protrusions that extend a longitudinal length of an interior of the outside collar; and/or the rows of internal protrusions extend an entire circumference of the interior of the outside collar.

Another aspect of the invention involves a method of using the torque limiting threaded fastener of the aspect of the invention described above. The method comprising disposing the inside collar into the outside collar; rotating the bolt so that the internal threads of the inside collar threadably receive the external threads of the bolt, causing the bolt to screw into the inside collar; upon rotation of the bolt a predetermined torque amount, the plurality of external protrusions of the inside collar slipping past the plurality of internal protrusions of outside collar, limiting torque and prevent stripping in the torque limiting threaded fastener.

One or more implementations of the aspect of the invention described immediately above includes one or more of the following: the outside collar includes elastic material that compresses when the bolt is rotated a predetermined torque amount so that that the plurality of external protrusions of the inside collar slip past the plurality of internal protrusions of outside collar; the elastic material of the outside collar is cylindrical and circumferentially surrounds the plurality of internal protrusions of the outside collar; the plurality of external protrusions of the inside collar are at least one of serrations and triangles; the plurality of external protrusions of the inside collar includes rows of external protrusions that extend a longitudinal length of an exterior of the inside collar; the rows of external protrusions extend an entire circumference of the exterior of the inside collar; the plurality of internal protrusions of the outside collar are at least one of serrations and triangles; the plurality of internal protrusions of the outside collar includes rows of internal protrusions that extend a longitudinal length of an interior of the outside collar; and/or the rows of internal protrusions extend an entire circumference of the interior of the outside collar.

The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a torque-limiting threaded fastener, constructed and operative according to the teachings of the present invention.

FIG. 1 shows an exploded perspective view illustrating a torque-limiting threaded fastener according to an embodiment of the present invention.

FIG. 2 shows a top plan view of an embodiment of an inside collar of the torque-limiting threaded fastener of FIG. 1.

FIG. 3 shows a top plan view of an embodiment of an outside collar of the torque-limiting threaded fastener of FIG. 1.

The various embodiments of the present invention will hereinafter be described in conjunction with the appended drawings.

### DETAILED DESCRIPTION

As discussed above, embodiments of the present invention relate to a threaded fastener device and more particularly to a torque-limiting threaded fastener 10, a specially designed set of bolts 20 and nuts 30 outfitted with a unique anterior and interior configuration of retractable, gripping teeth components 100, 110 structured and arranged to provide an easy means of preventing stripped bolts while also improving torque load on the bolts 20.

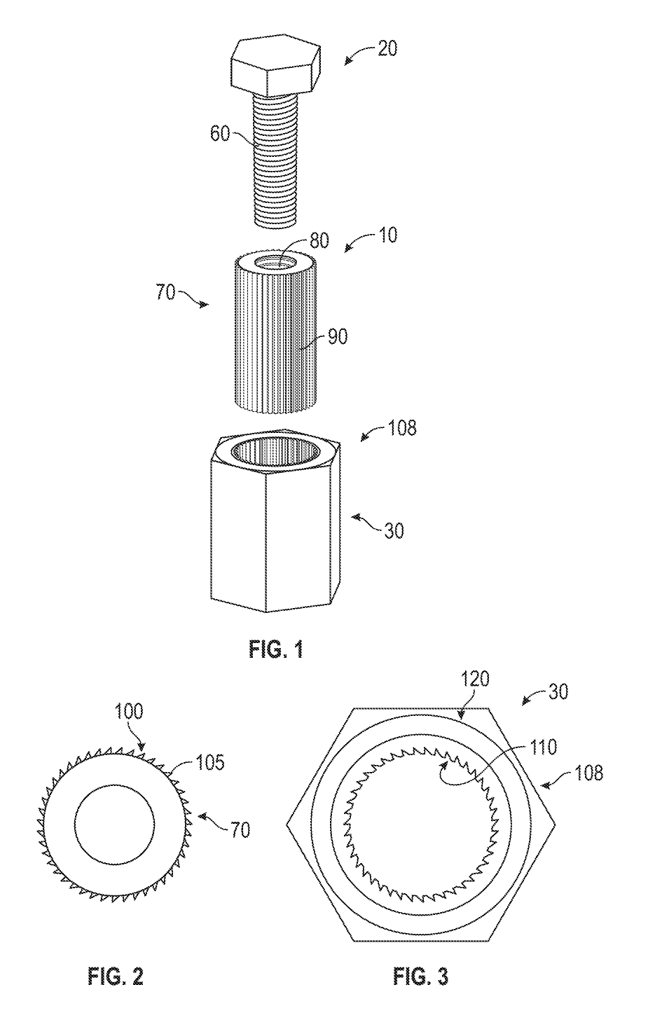

Referring now to the FIGS. 1-3, the torque-limiting threaded fastener 10 may be a cylindrical fitting, with a wide variety of size configurations to accommodate any job at hand. The torque-limiting threaded fastener 10 includes the bolt 20 with external threads 60. An inside threaded cylindrical collar 70 has internal threads 80 that threadably receive the external threads 60 of the bolt 20 and an outside/external periphery 90. The outside/external periphery 90 has multiple protrusions in the form of “triangles” or serrations 100 extending radially externally from the external periphery 90. The serrations 100 include inclined tips 105 that extend longitudinally on the external periphery 90 in rows circumferentially spaced thereon. An outside collar 108 has multiple internally disposed protrusions in the form of triangles or serrations 110 in reverse orientation to the external serrations 100 of the inside collar 70 to provide a ramp for the external serrations 100 of the inside collar 70 to rotate around and relative to when rotated counter clockwise, unlocking the bolt 20 and inside collar 70 relative to the outside collar 108, but still lock into place the bolt 20 and inside collar 70 when rotated clockwise. This allows the bolt 20 to be removed. A cylindrical elastic material 120 is disposed between the internally disposed triangles or serrations 110 and a frame 130 of the bolt 20. The elastic material 120 can be compressed and restores rigidity when tension is removed.

In use, the inside collar 70 is inserted into the outside collar 108, and the bolt 20 is inserted into the inside collar 70. The bolt 20 is rotated clockwise so that the internal threads 80 of the inside collar 70 threadably receive the external threads 60 of the bolt 20. To prevent over-tightening and stripping of the bolt 20, when the rotation of the bolt 20 gets to a predetermined torque amount, the cylindrical elastic material compresses enough so that the external serrations 100 of the inside collar 70 will slip past the internal serrations 110 of the outside collar 108 so that the inside collar 70 rotates within and relative to the outside collar 108. When one sees the inside collar 70 rotating within and relative to the outside collar 108, the user knows that the bolt 20 has exceeded the predetermined torque amount for the torque-limiting threaded fastener 10, and, therefore, there is no need to attempt to increase the torque on the bolt 20.

The torque-limiting threaded fastener 10 is an innovative product which would offer a number of significant benefits and advantages. Foremost, the torque-limiting threaded fastener 10 provides mechanics, contractors, plumbers, repairmen, and do-it-yourselfers a highly functional set of tool accessories that fully maximize the potential of ubiquitous fasteners. Featuring a multitude of bolts 20 outfitted with internal and external gripping teeth, the torque-limiting threaded fastener 10 would facilitate effortless extraction of any nut or bolt configuration, eliminating the time-consuming frustrations commonly associated with stripped fasteners that can, sometimes, be completely impossible to remove. In addition to eliminating over-tightening, the torque-limiting threaded fastener 10 would allow both extraction and installation tasks to be completed in a matter of seconds. Durably constructed, the torque-limiting threaded fastener 10 withstand years of repeated use.

The torque-limiting threaded fastener 10 revolutionizes the fastener industry. Easily used, the torque-limiting threaded fastener 10 allows the user to remove any bolt, nut, or screw, with little effort and without any other special tools, without stripping/overtightening problems. Additional advantages of the torque-limiting threaded fastener 10 include enhanced durability, provides a guaranteed satisfaction of desired torque, prevents ever stripping a bolt again. Operational uses for the bolt would remain the same as existing products but the internal components allow for easier use for the product. The torque-limiting threaded fastener 10 allows nuts to be manufactured to a specific torque unlike products on the market today. The torque-limiting threaded fastener 10 may replace nuts currently on the market that partner with components that that are very costly if the bolt is damaged (e.g., engine block, toilet, lug nut).

The figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A torque limiting threaded fastener, comprising:
a bolt with external threads;
an inside collar with internal threads that threadably receive the external threads of the bolt, the inside collar including a plurality of external protrusions;
an outside collar that receives that inside collar, the outside collar including a plurality of internal protrusions,
wherein when the bolt is rotated a predetermined torque amount, the plurality of external protrusions of the inside collar slip past the plurality of internal protrusions of outside collar, limiting torque and prevent stripping in the torque limiting threaded fastener.

2. The torque limiting threaded fastener of claim 1, wherein the outside collar includes elastic material that compresses when the bolt is rotated a predetermined torque amount so that that the plurality of external protrusions of the inside collar slip past the plurality of internal protrusions of outside collar.

3. The torque limiting threaded fastener of claim 2, wherein the elastic material of the outside collar is cylindrical and circumferentially surrounds the plurality of internal protrusions of the outside collar.

4. The torque limiting threaded fastener of claim 1, wherein the plurality of external protrusions of the inside collar are at least one of serrations and triangles.

5. The torque limiting threaded fastener of claim 1, wherein the plurality of external protrusions of the inside collar includes rows of external protrusions that extend a longitudinal length of an exterior of the inside collar.

6. The torque limiting threaded fastener of claim 5, wherein the rows of external protrusions extend an entire circumference of the exterior of the inside collar.

7. The torque limiting threaded fastener of claim 1, wherein the plurality of internal protrusions of the outside collar are at least one of serrations and triangles.

8. The torque limiting threaded fastener of claim 1, wherein the plurality of internal protrusions of the outside collar includes rows of internal protrusions that extend a longitudinal length of an interior of the outside collar.

9. The torque limiting threaded fastener of claim 8, wherein the rows of internal protrusions extend an entire circumference of the interior of the outside collar.

10. A method of using the torque limiting threaded fastener of claim 1, comprising:
disposing the inside collar into the outside collar;
rotating the bolt so that the internal threads of the inside collar threadably receive the external threads of the bolt, causing the bolt to screw into the inside collar;
upon rotation of the bolt a predetermined torque amount, the plurality of external protrusions of the inside collar slipping past the plurality of internal protrusions of outside collar, limiting torque and prevent stripping in the torque limiting threaded fastener.

11. The method of claim 10, wherein the outside collar includes elastic material that compresses when the bolt is rotated a predetermined torque amount so that that the plurality of external protrusions of the inside collar slip past the plurality of internal protrusions of outside collar.

12. The method of claim 11, wherein the elastic material of the outside collar is cylindrical and circumferentially surrounds the plurality of internal protrusions of the outside collar.

13. The method of claim 10, wherein the plurality of external protrusions of the inside collar are at least one of serrations and triangles.

14. The method of claim 10, wherein the plurality of external protrusions of the inside collar includes rows of external protrusions that extend a longitudinal length of an exterior of the inside collar.

15. The method of claim 14, wherein the rows of external protrusions extend an entire circumference of the exterior of the inside collar.

16. The method of claim 10, wherein the plurality of internal protrusions of the outside collar are at least one of serrations and triangles.

17. The method of claim 10, wherein the plurality of internal protrusions of the outside collar includes rows of internal protrusions that extend a longitudinal length of an interior of the outside collar.

18. The method of claim 17, wherein the rows of internal protrusions extend an entire circumference of the interior of the outside collar.
